(19) United States
(12) Patent Application Publication
(10) Pub. No.: US 2013/0297414 A1
(43) Pub. Date: Nov. 7, 2013

(54) METHOD, APPARATUS, AND COMPUTER-READABLE MEDIUM FOR MANAGING MOBILE PAYMENT TRANSACTIONS

(71) Applicant: FLINT MOBILE, INC., Redwood City, CA (US)

(72) Inventors: Greg Goldfarb, San Francisco, CA (US); Paulo Ferreira, Vancouver (CA); Sergei Gouzeev, Discovery Bay, CA (US); Zachary Nelson, South San Francisco, CA (US); Dan Nieuwland, Toronto (CA); Venkat Subramanian, San Jose, CA (US); Gary Gippetti, San Jose, CA (US); Ben Flores, San Francisco, CA (US)

(73) Assignee: FLINT MOBILE, INC., Redwood City, CA (US)

(21) Appl. No.: 13/840,500

(22) Filed: Mar. 15, 2013

Related U.S. Application Data
(60) Provisional application No. 61/643,865, filed on May 7, 2012.

(51) Int. Cl. G06Q 40/00

(52) U.S. Cl. CPC G06Q 40/00
USPC 705/14.51; 705/39; 705/44

(57) ABSTRACT

An apparatus, computer-readable medium, and computer-implemented method for managing mobile payment transactions includes receiving transaction data from a mobile device of a merchant, the transaction data including payment card information associated with a customer and transaction details information relating to the transaction, and the payment card information being captured with the mobile device of the merchant, storing a transaction record including the transaction details information in an online merchant account registered to the merchant, the online merchant account storing transaction records associated with the merchant, and providing access to the transaction records through the online merchant account.

### RELATED APPLICATION DATA

This application claims priority to U.S. Provisional Application No. 61/643,865, filed May 7, 2012, the disclosure of which is hereby incorporated by reference in its entirety.

### BACKGROUND

Conventionally, for a customer to purchase goods or services with a payment card (e.g., credit card or debit card), the customer would swipe their card through a point of sale (POS) terminal and the terminal would communicate with a payment gateway to authorize the purchase. Alternatively, a merchant could key in the customer's card information at a POS terminal for payment authorization. To purchase goods or services remotely, many merchants allow customers to enter card information via a website. Additionally, many merchants utilize card reader accessories, such as a dongle from Square™ which plugs into the headphone jack of a mobile device.

As cameras have become integrated in more computing devices, systems have been implemented to allow for optical input of payment card information. For example, Jumio offers systems that allow a customer to take a picture of the entire front of their payment card with a webcam or phone camera. The Jumio system then recognizes card data (e.g., account number, expiration date, account holder name, card type, etc.) so that a user does not have to manually enter the card data from the front of the card. However, while such a system may take some of the hassle out of paying with a card, having a computing device take a picture of the entire front of a payment card may also raise security concerns.

Card.io offers a similar system that allows a customer to take a video scan of the entire front of their payment card with a webcam or phone camera. To alleviate some security concerns, Card.io is designed to avoid storage of the card scan data and to transmit card scan data to servers via encrypted communications. Though Card.io may be more secure than systems that store an image of a payment card on a user's computer or phone, such a system may still raise security concerns. For example, a malicious program may still take a screenshot of the entire face of the card displayed on the display of the device. Alternatively, a malicious program may access the card scan from active memory even though the card scan is never stored in a non-volatile memory. The account information displayed on the front of the payment card may even be intercepted by a bystander who can see the screen of a smartphone utilizing such a system.

Additionally, the infrastructure of the existing payment platforms is limited in scope. Merchants who utilize the existing systems do not have a customizable way of making use of the transaction data relating to customer transactions, much of which could be useful for marketing or record keeping purposes.

Improved systems for managing mobile payment transactions are desired.

### BRIEF DESCRIPTION OF THE DRAWINGS

FIG. 1 illustrates a flowchart for managing mobile payment transactions according to an exemplary embodiment.

FIGS. 2A-2J illustrate mobile device interfaces for conduction a transaction according to an exemplary embodiment.

FIGS. 3A-3B illustrate interfaces for online merchant account registration according to an exemplary embodiment.

FIG. 4 illustrates a merchant account introductory screen according to an exemplary embodiment.

FIG. 5 is diagram of options available to registered merchants according to an exemplary embodiment.

FIG. 6 illustrates a online merchant account profile interface according to an exemplary embodiment.

FIGS. 7A-7E illustrate interfaces for accessing merchant transaction records according to an exemplary embodiment.

FIG. 8 illustrates a transaction receipt according to an exemplary embodiment.

FIG. 9 illustrates a customer feedback sharing interface according to an exemplary embodiment.

FIGS. 10A-10B illustrate online merchant account linked social media service features according to an exemplary embodiment.

FIG. 11 illustrates a merchant review on the social media page of a customer according to an exemplary embodiment.

FIG. 12 illustrates a process flow diagram of transaction processing according to an exemplary embodiment.

FIG. 13 illustrates flow chart of premium merchant membership dues deduction according to an exemplary embodiment.

FIG. 14 illustrates an exemplary computing environment that can be used to carry out the method for managing mobile payment transactions according to an exemplary embodiment.

### DETAILED DESCRIPTION

While methods, apparatuses, and computer-readable media are described herein by way of examples and embodiments, those skilled in the art recognize that methods, apparatuses, and computer-readable media for managing mobile payment transactions are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

Applicants have discovered a way of managing mobile payment transactions which stores transaction details relating to the transaction and allows merchants to make use of the stored transaction information via an online merchant account. Merchants can utilize the online merchant account to access and review transaction information, customize receipts to be sent to customers, and customize promotional and marketing materials.

The online merchant account can be accessed and configured using any computing device via a web browser and web interface, as well as via a remote application such as a mobile application running on a mobile device or an application running on computer. For example, merchants can download a mobile application that is linked to their online merchant account and is able to access data stored in the online merchant account and configure the online merchant account. The online merchant account can be hosted by one or more servers and be accessible through a web interface and through a mobile application interface. So, for example, when a merchant adjusts their preferences for their online merchant account through a mobile application, those adjusted preferences can be reflected when they access their online merchant account via a web interface.

Merchants can also link social network pages or other social media to their online merchant accounts for use with the online merchant account services. Additionally, applicants have discovered a way of capturing payment information from a payment card which provides enhanced security features.

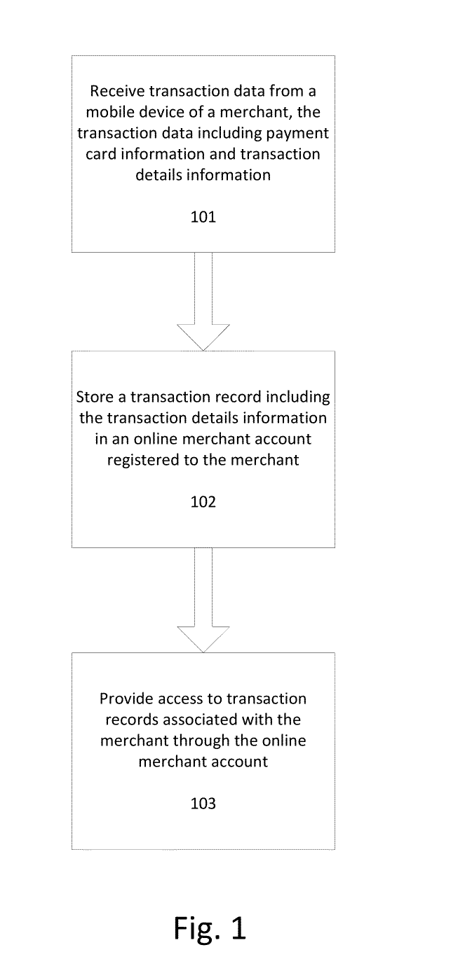

FIG. 1 is flowchart showing a method of managing mobile payment transactions according to an exemplary embodiment. At step 101, transaction data is received from a mobile device of a merchant. The transaction data includes payment card information associated with a customer and transaction details information relating to the transaction. Payment card information can include information such as card number, expiration date, card verification value (CVV), cardholder's name, and other payment card related information. The transaction details information can include information such as the date and time of the transaction, transaction number, customer contact information, item purchased, transaction amount, transaction location, coupons or promotions used, and any other information related to the circumstances or content of the transaction or the customer participating in the transaction. Additionally, the item purchased does not have to be a product, but can also be a service, agreement, warranty, or some other commodity.

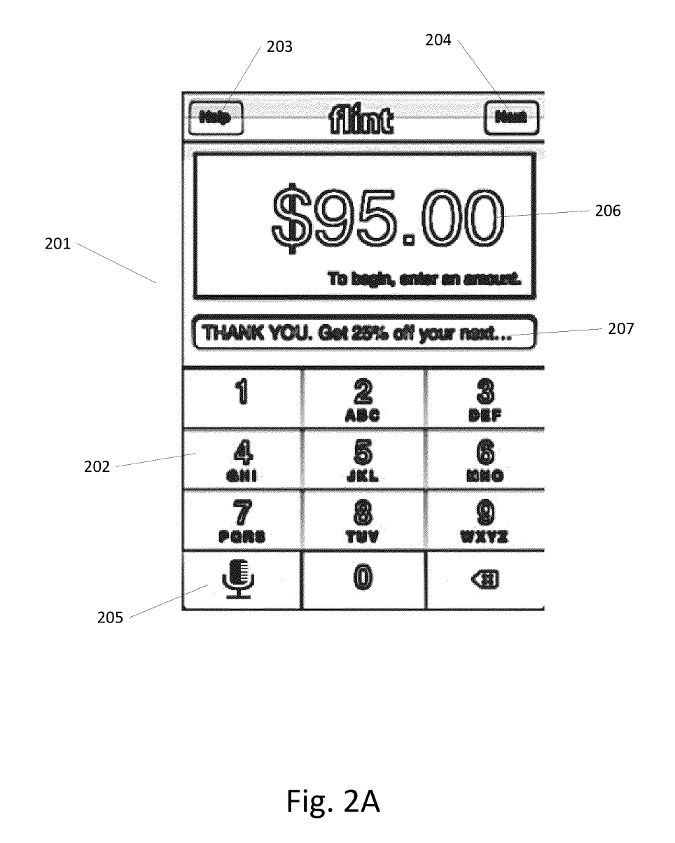

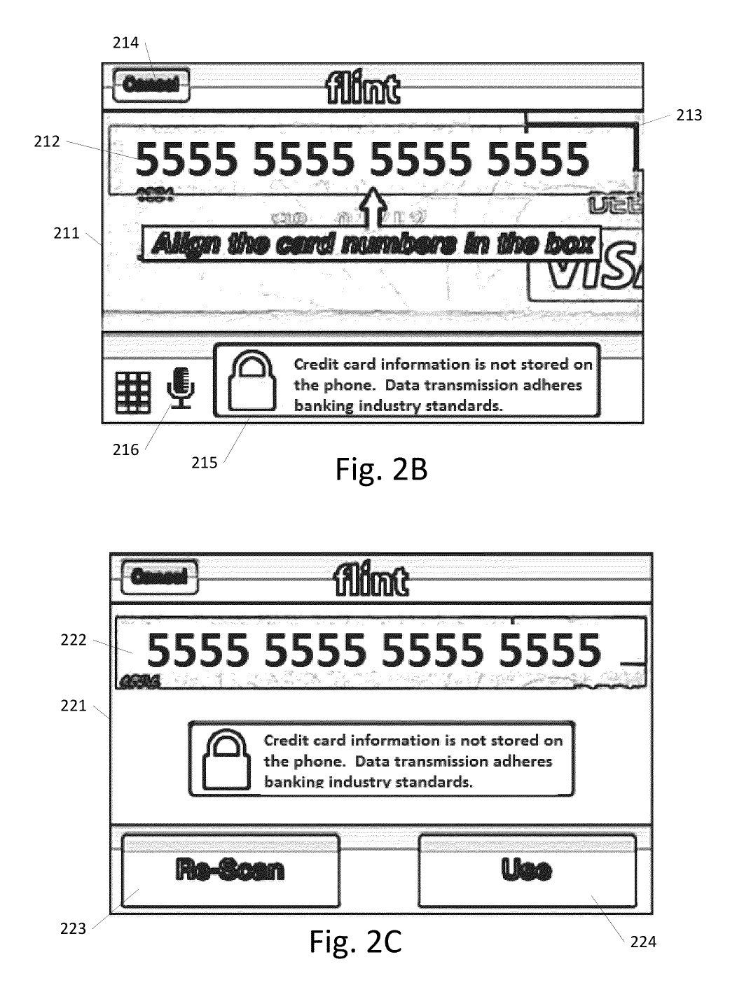

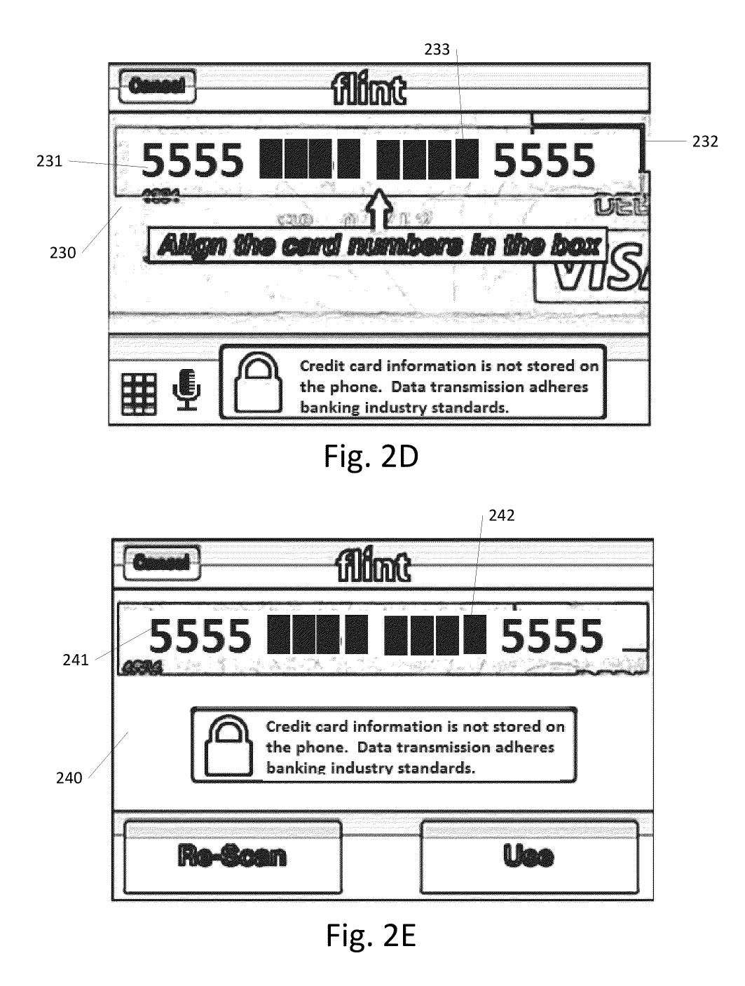

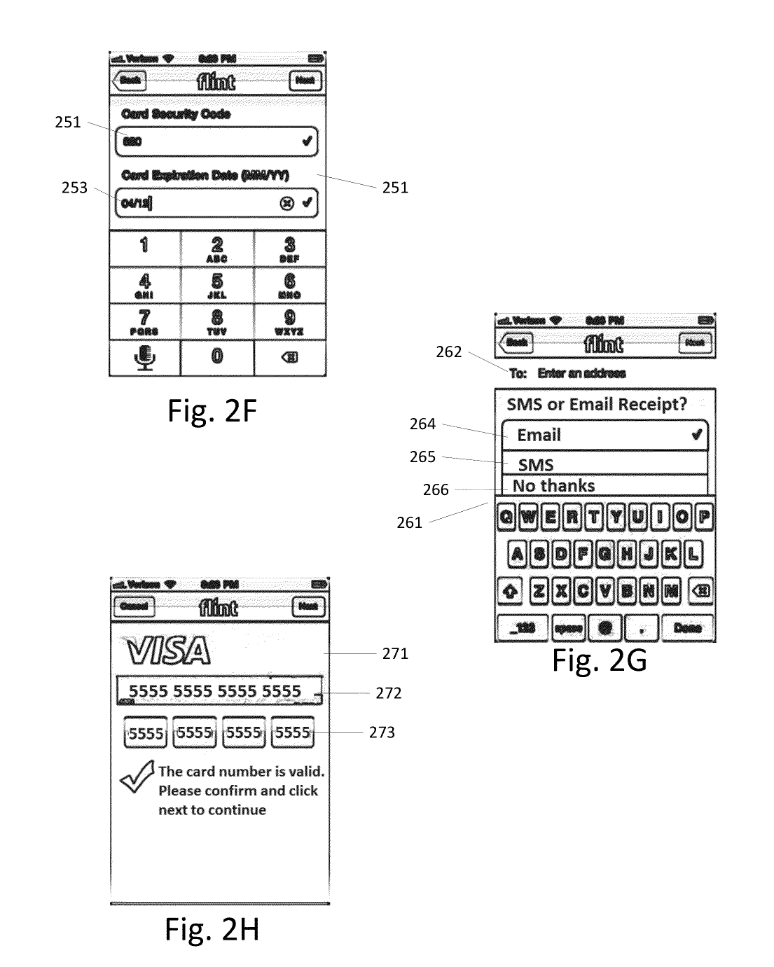

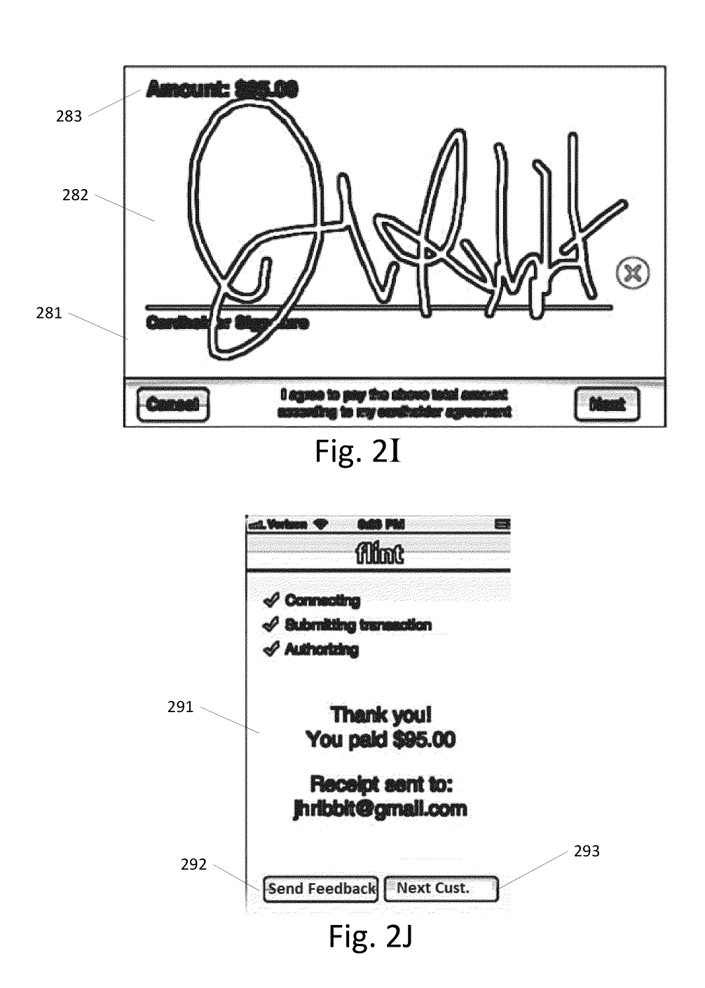

The actual transaction process can be described from the point of view of a merchant that is using the system. The merchant can start by entering a payment amount. For example, FIG. 2A shows a user interface 201 that prompts the merchant to enter the payment amount 206. The user interface can be part of a mobile application on the mobile device, or can be a server-side application that is displayed on the mobile device. The interface 201 can display a number pad 202 for entering the payment information, and can also have a voice-to-text button 205 that allows the merchant to speak the amount. The interface 201 includes a help button 203 which can bring up a help menu or help screen to assist the merchant. Also shown is a promotional message 207 which the merchant can customize or remove and which can be sent to the customer, as will be described later. When the merchant has entered an amount, he can continue the transaction process by selecting the next button 204.

The payment card information can be captured with the mobile device of the merchant via a variety of methods. Payment card information can be captured using an image capture device, such as a camera or video camera. The interface can include features which enhance the security of the payment card information capture process. For example, the interface can also be configured to capture an image of the face of a payment card in a way that detects the position of various data without requiring border information. Therefore, unlike conventional optical capture card payment systems, the entire face of a payment card is not required to be captured.

FIG. 2B shows an example of this image capture process. The interface 211 prompts the user, which can be the merchant or the customer, to position the card so that the card number 212 is within a box 213 that is displayed on the interface 211. The user can be given the option to cancel the transaction via cancel button 214. Additionally, a message 215 may displayed to the user assuring them that payment card information is not stored on the phone. The user can also have the option of selecting a voice-to-text button 216 that allows them to speak a credit card number instead. Using this interface, it is not necessary to take a picture of the entire card and the payment card information can be entered in increments for greater security. The capture of payment card information by requiring the user to align some data field with an onscreen indicator may be used for other payment card data as well, such as the expiration date or name of the cardholder. The interface can include only portions of a front of a payment card in a field of view (e.g., only the account number in one capture, an expiration date and an account holder's name in another, etc.) for added security. Thus, a subset of payment card information may be captured in a single image.

Referring to FIG. 2C, after the payment card number is captured, the captured number 222 can be displayed on the interface 221. The user can elect to use this number 224 or re-scan 223 if the number is unclear or a different payment card is desired. If the card number was entered by voice, an option to speak the number again may be presented so that the user can re-enter the number if it was not captured correctly.

The interface can provide security features to avoid capturing or displaying on a device's screen various payment data. For example, a blocking mask may cover various parts of the field of view of a camera to cover digits of a card number, the expiration date of a payment card, the account holder's name from a payment card, or any other data. FIG. 2D shows an interface 230 that is similar in many respects to the interface of FIG. 2B. The interface 230 prompts the user to position the card number 231 within the box 232. The interface 230 additionally includes a blocking mask 233 which obfuscates one or more digits of the card so that they are not visible on the display of the mobile device. This feature can give a customer added reassurance when a merchant is capturing their payment card information.

FIG. 2E shows an interface 240 after the card number 241 is captured. As shown, the blocking mask 242 can be kept in place for the verification step, and the user can verify the card number based on the digits that are not obfuscated. Of course, the verification may include a variety of security measures to prevent portions the account data from being simultaneously displayed. For example, a user may verify only blocks of data at a time (e.g., in 4 digit segments) or a user may be presented a progressive display (e.g., a swipeable or scrollable user interface) that allows the user to navigate to various data without it all being simultaneously displayed.

Of course, the card number and any other payment card information does not need to be captured using an image capture device. The interface may present an option to the user to speak the card number into a microphone on the mobile device and use voice-to-text translation to convert the audio information and capture the card number. Additionally, card number can be captured with a number pad on the interface, either as an initial option, or in a situation where the card number cannot be accurately captured in other ways. For example, in certain lighting conditions, capture of the card number may be difficult, and after a failed attempt the user can be presented with an option to input the card number via a number pad on the interface.

FIG. 2F shows another interface 251 that can be used to enter additional payment card information. The user can enter the card security code (CVV) in text entry box 251 and the expiration date of the card in text entry box 253. As discussed earlier, this information can be entered via image or voice capture as well. The payment card information can be captured using different input methods for each piece of payment card information. For example, the payment card number can be captured via the image capture device, and other card information, such as the name or CVV can be entered by voice.

Referring to FIG. 2G, the user can optionally enter an address to which a receipt of the transaction will be sent. The interface 261 allows the user to enter an address 262 and to select whether the receipt should be sent via email 264, or SMS 265. Additionally, a “no thanks” option 266 is presented if no receipt is desired. This information can be entered via text input, selecting from a list of contacts, or voice capture as well.

FIG. 2H shows an interface 271 of a confirmation screen that can be presented to the user. The confirmation screen can indicate that the card number is valid and display the card number as captured 272 and as parsed 273. The user can then confirm and select the next button to continue. Of course, the card number can be partially obfuscated as before or withheld for additionally security. As before, a user may verify only blocks of data at a time (e.g., in 4 digit segments) or a user may be presented a progressive display (e.g., a swipeable or scrollable user interface) that allows the user to navigate to various data without it all being simultaneously displayed. This can be based on the merchant's or the customer's preferences and configured through an option presented on the interface or via a preferences menu.

Referring to FIG. 21, an interface 281 is shown which allows the customer to enter their signature 282. The customer can use their finger to sign a touch screen of the mobile device, or alternatively they can use a stylus or some other writing implement configured for use with the mobile device. The amount of the transaction 283 may also be presented on the interface 282. Of course, biometric means of authentication and verification can also be used, such as voice recognition or fingerprints.

In FIG. 2J a transaction verification interface 291 is shown. Information confirming the transaction can be displayed on the interface 291 along with the payment amount and the receipt information. The merchant may also select the send feedback button 292 if they wish to provide feedback regarding the transaction process, such as an error or glitch that they experienced. Otherwise, the merchant can select the next customer button 293 and proceed to the next transaction.

Of course, the merchant can also accept payment from customer's via other means, such as a mobile wallet. The merchant's mobile device can be used to scan a customer barcode or a two-dimensional barcode (“QR code”). Additionally, near-field-communication technology can be used to detect the customer's payment information, such as by placing the merchant's mobile device in proximity to the customer's mobile device. If these technologies are used, then the payment card information can be replaced with the payment information in the transaction data that is received.

Referring back to FIG. 1, after the transaction data, including the payment card information and transaction details information is received from the mobile device of the merchant, a transaction record is stored at step 102. The transaction record includes the transaction details information and is stored in an online merchant account that is registered to the merchant. The online merchant account can store a plurality of transaction records that are associated with the merchant.

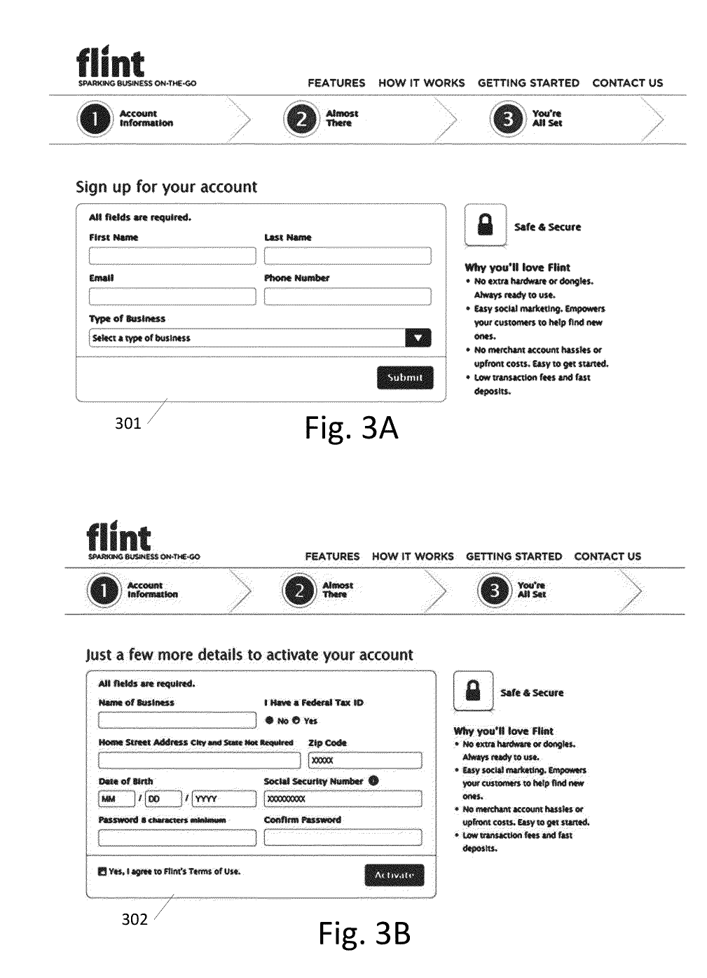

The registration process for the online merchant account will now be described in greater detail. A merchant can navigate to a registration web page, either on their mobile device or on another computing device with a web browser. Alternatively, the merchant can download a mobile app or other application which initiates the registration process. In order to register, the merchant can be required to enter personal and business related data. This data can include name, email address, phone number, type of business, name of business, home address, business address, date of birth, social security number. The merchant can also be given the option to select a user name or password. FIG. 3A illustrates a merchant registration interface 301 according to an exemplary embodiment. After the merchant completes the information in the interface 301, they can then be presented with a second interface 302, shown in FIG. 3B, which solicits additional information. The merchant can then choose to activate their account. Of course, the information and registration can be accomplished using a single interface or multiple interfaces, and can require more or less information. These examples are provided for the purpose of illustrating the registration process only and are not meant to be limiting.

If the merchant registered using a web browser, they can be given the option of downloading a mobile application on to their phone or other mobile device. After activation, the merchant can access their online merchant account and provide initial setup information. Setup information can include information that allows the computing system and online merchant account to identify the merchant's mobile device, such as a device ID of the mobile device. The merchant can also download and install any necessary software, such as provisioning software, to their computing devices and mobile device. The online merchant account can be accessed through the mobile application or a web browser on the merchant's mobile device or through a web browser or application on another computing device.

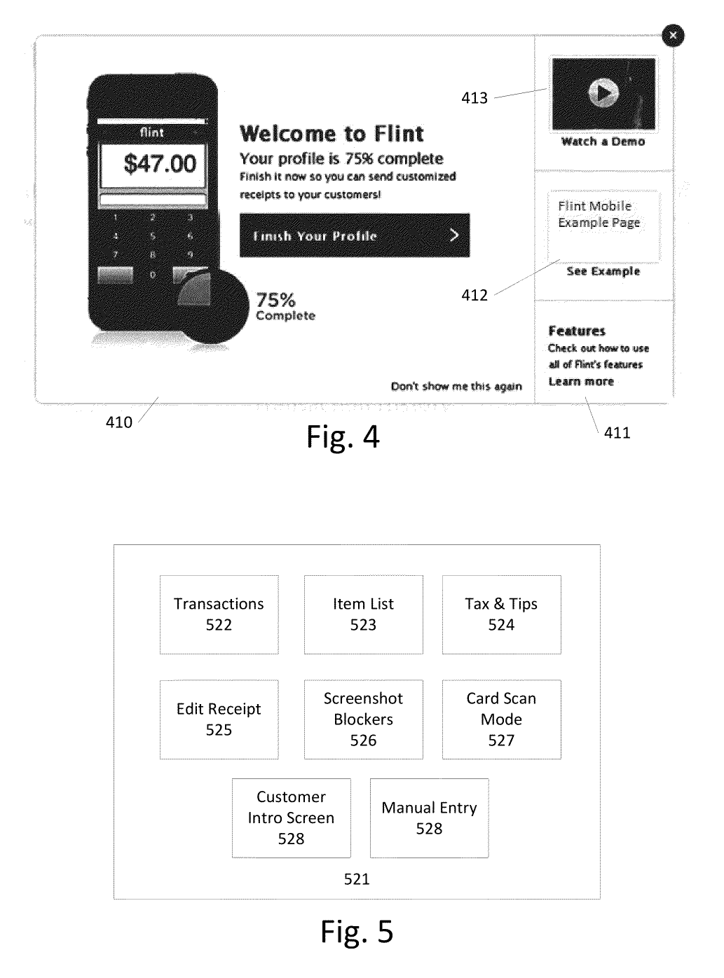

The first time the merchant accesses their online merchant account they may be presented with an introductory screen, such as the one shown in FIG. 4. The interface 410 can include options to watch a demo 413 of the online merchant account or mobile app features, see an example 412 of the online merchant account or mobile app features, or learn more 411 about the online merchant account or mobile app features. Additionally, the introductory screen can include many other links that may be helpful to the merchant, such as a links to an FAQ or technical support.

Some of the options 521 available to registered merchants are shown in FIG. 5. The options 521 can include viewing past transactions 522, including the ability to void individual transactions. Options 521 can also include the ability to create customized item lists 523 in order to process transactions faster. For example, a food vendor can create a customized list of all the items on the menu, along with the associated prices, so that they can just select the purchased items and do not have to enter the prices of the items individually during a transaction. The options 521 can also include tax and tip customization 524 for transactions, the ability to edit the receipt 525 sent to customers after a transaction, customization of screenshot blockers 526 used during payment card capture, customization of the card scan mode 527, for example, by choosing whether the camera automatically detects payment card numbers or whether a user must select a scan button on the interface to scan the card numbers. A customer intro screen 528 may also be toggled on or off. This screen can be useful in introducing new customers to the payment platform. Additionally, manual entry 528 of payment card information can also be selected in certain situations if desired.

Optionally, any of these options can be input or adjusted using voice recognition and voice-to-text conversion. For example, the customized item lists 523 can be entered by the merchant speaking each of the items and associated prices, or by speaking the items and inputting the associated prices. The voice-to-text function can be toggled with a button on an interface presented to the merchant. Many variations are possible and these examples are not intended to be limiting.

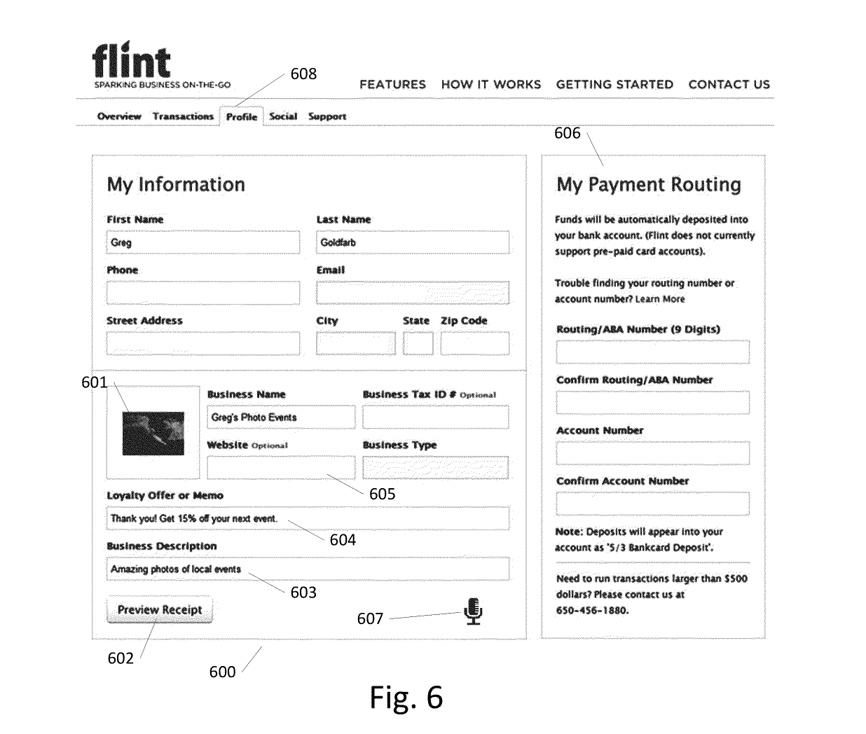

The online merchant account can include a profile interface, such as the one shown in FIG. 6. The profile interface 600 allows the merchant to edit personal and business information and can be one interface section 608 in a plurality of interface sections accessible to the merchant. Other interface sections can include an overview section, a transactions section, a social media section, and a support section. These will be described in greater detail below.

In the profile interface 600, the merchant can enter information that will be included on receipts sent to customers. For example, the merchant can upload a logo or delete their current logo 601, enter their website information 605, enter their business name, enter a default promotional offer 604, and enter a description of their business 603. All of this information can be entered as text by the merchant or as spoken audio input and converted into text using voice-to-text conversion. Voice-to-text can be toggled or activated by selecting an appropriate icon 606. After the merchant has customized the receipt to their liking, they can then preview the receipt 602 to see what it will look like to a customer.

The profile interface 600 also includes input areas for payment routing information 606. The payment routing information can include the routing number of the merchant's bank account and the account number of the merchant's bank account. After the payment routing information is entered, the revenue from each of the merchant's transactions on the payment platform can be routed to their bank account after processing fees have been deducted. Of course, profile interface 600 can formatted for display and presentation on a mobile device, either through the mobile application interface or on a server side page which is designed for access by mobile devices.

Returning again to FIG. 1, access to the transaction records associated with the merchant is provided through the online merchant account at step 103. Each transaction record can include a plurality of data fields which are based on the transaction details information that is received with the transaction data for each transaction at step 101.

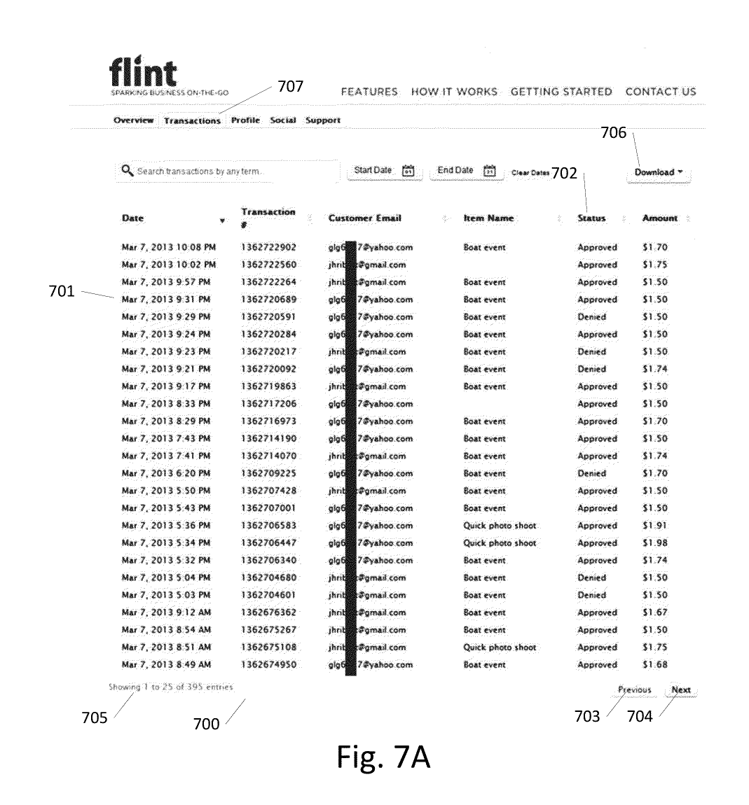

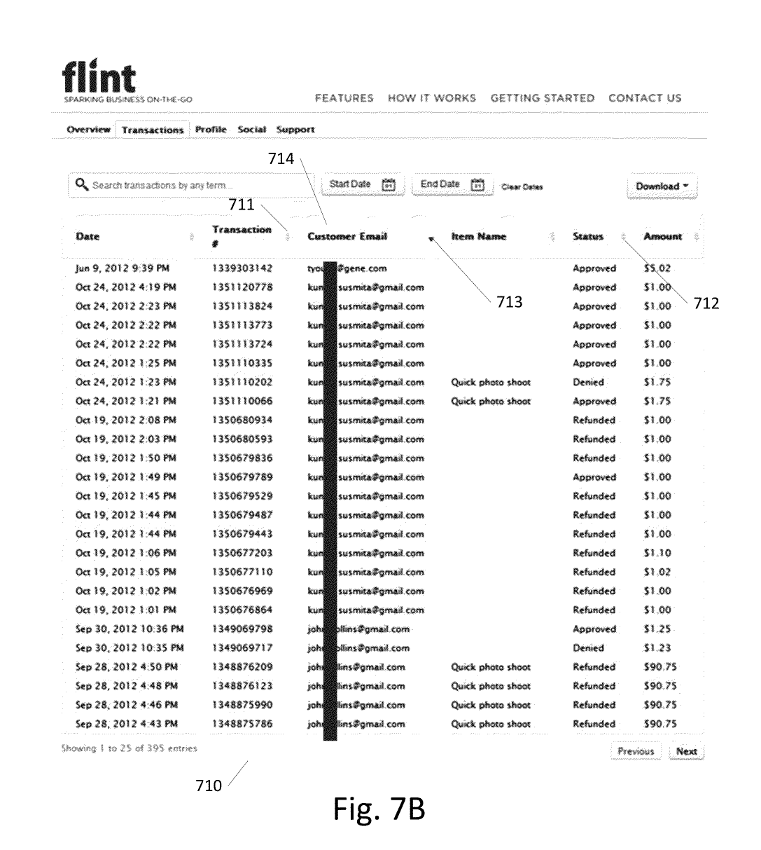

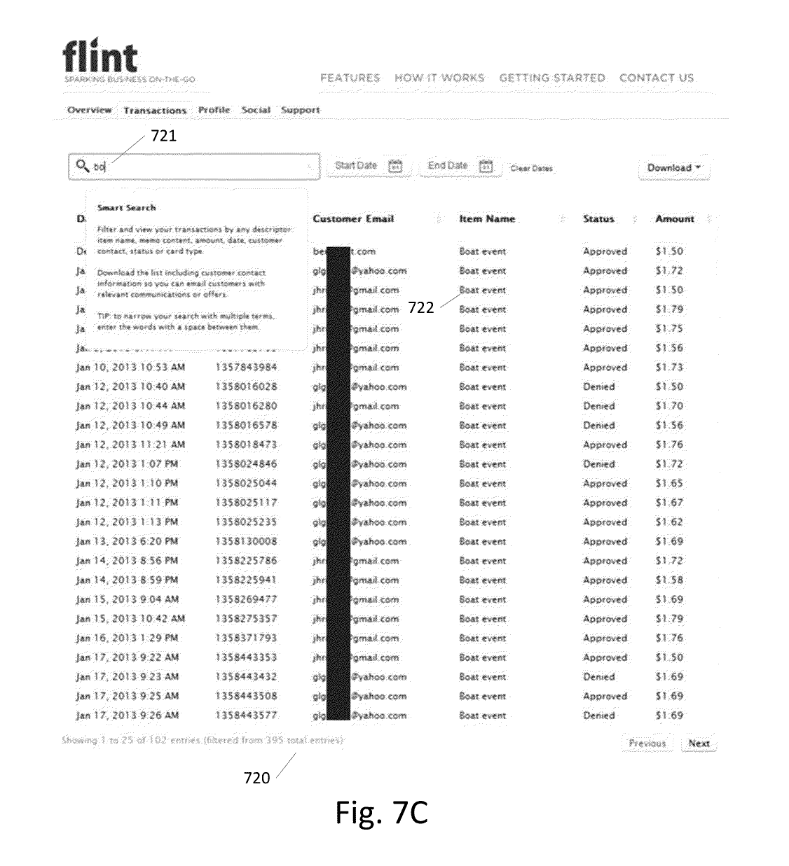

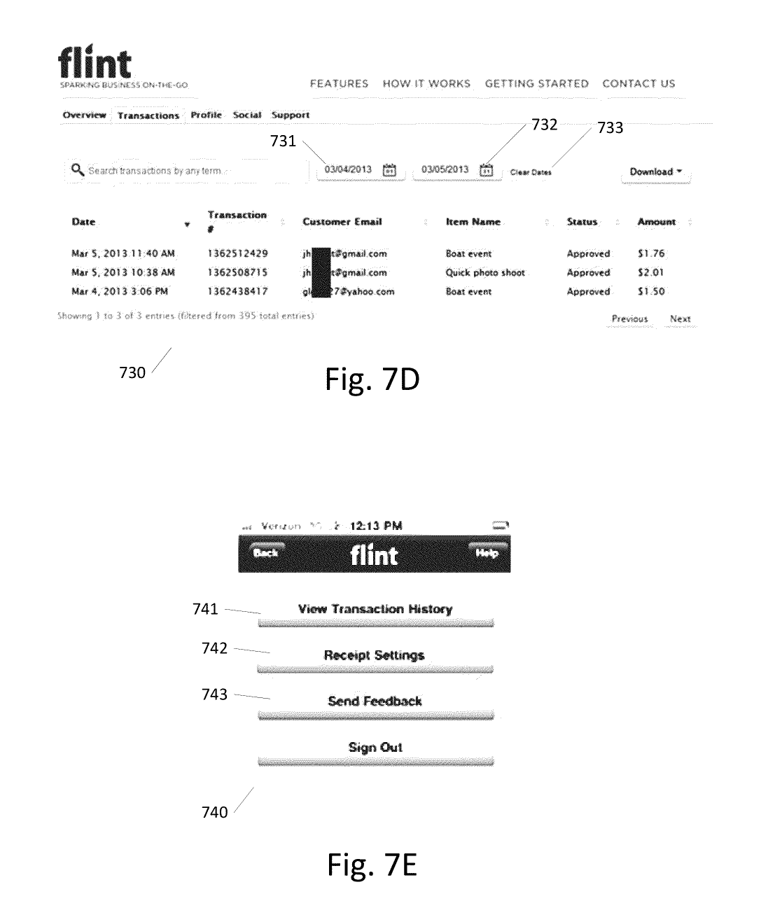

Referring to FIG. 7A, an interface 700 used to provide access to the transaction records associated with the merchant will now be described in greater detail. The interface 700 can be accessed by selecting the transactions section 707, shown as a tab. As described earlier, each transaction record can include a plurality of data fields, such as transaction date, transaction number, customer email, purchased item, transaction status, and transaction amount. The item does not have to be a physical product, and can also be a service, a warranty, or some other commodity. Interface 700 can include a table that shows one or more transaction records from which are associated with the merchant.

The online merchant account can store the transaction records for all of the transactions that the merchant has ever conducted. Optionally, the merchant can be given the option of customizing how far back they would like to keep transaction records. For example, a merchant can decide that they only want to keep transaction records for the past two years. The interface can present a subset of the transaction records 705 associated with the merchant and the presented transaction records can be initially sorted by a data field value, such as date, with the most recent transaction records first. If the merchant desires to view additional transaction records, they may use the previous 703 and next 704 buttons to view a different subset.

The rows of the table can correspond to transaction records and the columns of the table can correspond to data fields. For example, the row 701 is the transaction record for a transaction conducted on Mar. 7, 2013 at 9:31 pm. Similarly, column 702 is a data field column corresponding to a transaction status, approved or denied. The merchant can also have the option of downloading a subset of transaction records, such as by selecting the download button 706. This can be useful for a merchant who wishes to analyze past sales data, identify transaction trends, or conduct a marketing campaign with a subset of customers based on the transaction data.

Referring to FIG. 7B, the interface 710 may include a plurality of sort indicators, with each sort indicator corresponding to a data field and a sorting order. For example, sort indicator 711 corresponds to the transaction number data field and an ascending sort order, sort indicator 712 corresponds to the status data field and descending sort order. A selection of one of the of sort indicators is received, the transaction records are sorted according to the data field and sorting order which correspond to the selected sort indicator, and the table is updated with the newly sorted transaction records.

In FIG. 7B, the transaction records are shown sorted according to sort indicator 713, which corresponds to the customer email data field and a descending sort order. The data field headings can also be sort indicators, with the sort order determined based on the current ordering of transaction records. For example, if a merchant were to click on customer email heading 714, the table would be updated with the transaction records re-sorted in ascending customer email order.

The transaction records can also be searched by the merchant to identify matching transaction records. A text input of one or more characters can be received and used to update the table to include only transaction records which have a data field with a data value that includes the one or more characters. Referring the interface 720 shown in FIG. 7C, the merchant has entered the characters “bo” in the text box 721. Accordingly, the table has been updated to show only transaction records that include the characters “bo” in a data field. In this case, the data field item name includes the word “boat” 722. This updating process can happen as the merchant types the characters, and does not require the selection of search button. Additionally, the merchant can enter multiple terms separated by a delimiter, and update the table with transaction records having all of the terms in one or more data fields.

Referring to FIG. 7D, an interface 730 is shown which allows merchants to filter the transaction records by a date range. The date range is received from the merchant, including a start date 731 and an end date 732. The table is then updated to show only transaction records which have a transaction date within the date range. The merchant can clear the date range by selecting the “clear dates” button 733.

Of course, the interfaces described are for the purpose illustration only, and the functionality described can be implemented via a variety of interfaces and techniques. For example, the merchant can have a special interface on their mobile device for accessing the same functions in a format that is tailored to the mobile device. The interface can be an interface of the mobile app, or a server side application or page displayed on the mobile device through a browser or other program. The mobile interface can optionally include a subset of the functionality that is available through the online merchant account. For example, FIG. 7E illustrates a mobile online merchant account interface 740 that allows merchants to select a transaction history interface 741, a receipt settings interface 742, and a feedback interface 743.

As described earlier, a customer's contact information, such as an email address or a phone number, can be captured by the mobile device during the transaction, and received as part of the transaction details associated with that transaction records. This contact information can then be used to transmit a customized receipt to the email address or the phone number of the customer after the transaction is processed. The customized receipt includes merchant information specified by the merchant through the online merchant account.

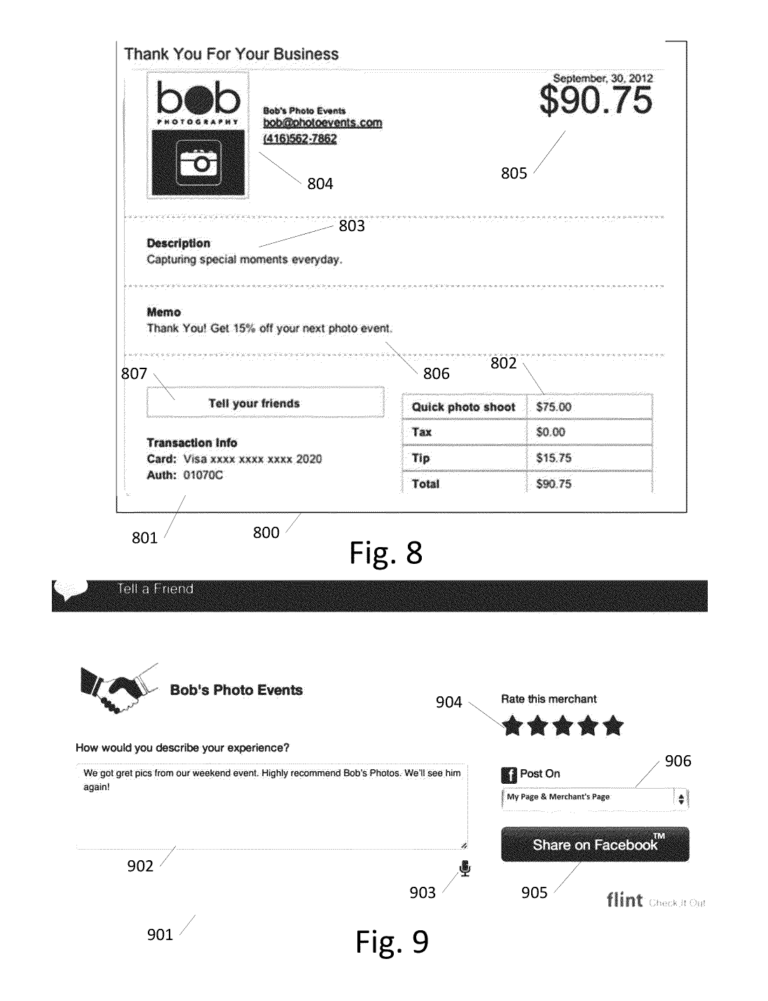

The interface for designing the receipt is described in greater detail earlier with reference to FIG. 6, and includes an option to customize the receipt with a promotional offer specified by the merchant through the online merchant account. FIG. 8 illustrates how a customized receipt 800 can look to a customer who has received the receipt via email. Receipt 800 can include payment card information 801, item information 802, the merchant's business description 803, merchant's logo and contact information 804, transaction date and transaction amount 805, and the merchant's promotional offer 806. The receipt can also include a link to a social media publishing page, the social media publishing page configured to publish a post regarding the merchant on one or more social media services, identified here as a “tell your friends” link 807. The social media service can be a social network, such as Facebook™, a review site such as Yelp™, or some other form of social media, such as Twitter™. Additionally, the receipt can include a link to make a post regarding the merchant directly on one or more social media services, for example, a link to the merchant's Facebook™ page.

FIG. 9 illustrates an interface 901 that can be presented to the user when they select the “tell your friends” link. Interface 901 includes a text area 902 where customers can provide a summary or feedback on the item, which can be a good or service. Optionally, customers can select a voice-to-text icon 903 to speak their comments and have them be converted into text. This icon can be presented on the interface 901 or can be on an interface of a mobile device that the customer is using. The interface can also include a rating scale 904 for rating the merchant. The social media service is shown as Facebook™ 905 but can be any social media service, such as the ones discussed earlier. A selector may also be presented on the interface to allow customers to select one or more social media services for posting to.

When the social media service is a service where the merchant has their own page and the customer also has their own page, such as a social network, an option may be presented to the customer 906 to post the their feedback or review on either the merchant's social media page, their own social media page, or both social media pages. Of course, social media pages include social network pages, such as pages on Facebook™.

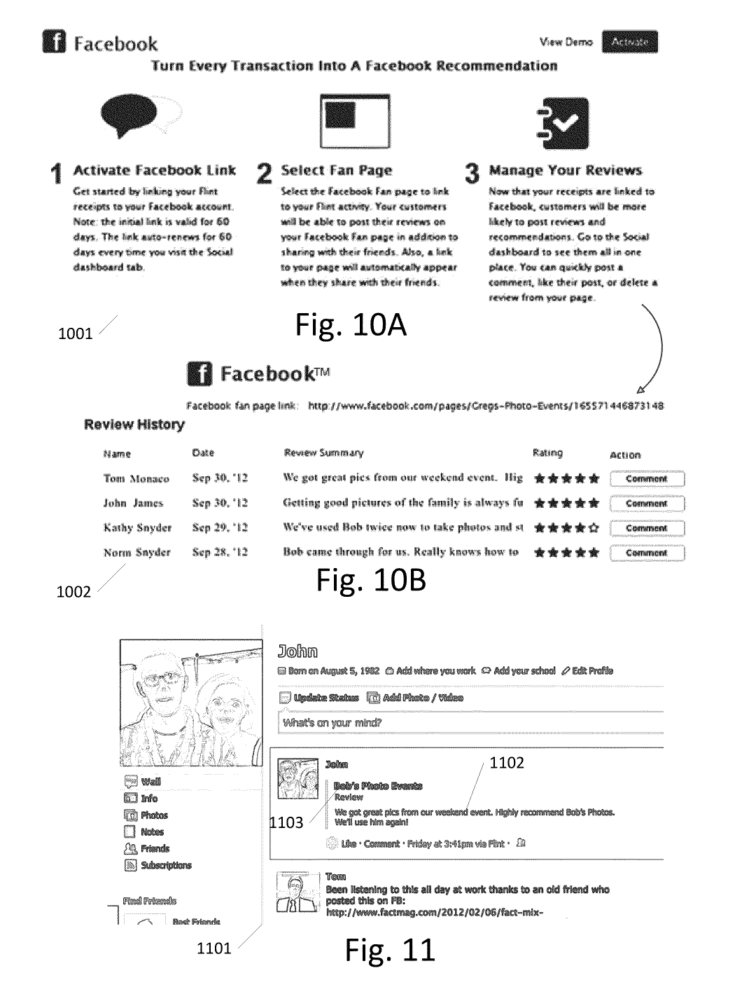

The merchant's social media pages can be linked to their online merchant account so that the post is automatically published to the merchant's social media page if the customer selects an option that includes posting to the merchant's page. For example, FIG. 10A illustrates an interface 1001 than can be presented to the merchant to allow them to link their social media account with their online merchant account. By linking their social media account with the online merchant account, the merchant can direct customer reviews and other feedback to their social media page through the link sent with receipts. Additionally, the merchant can receive publicity and traffic to their own social media page every time a customer publishes a post regarding the merchant, even if the post is on the customer's own social media page. The merchant can also manage, comment on, like, or delete reviews on their social media page through the online merchant account, as shown in interface 1002 of FIG. 10B. The text entered by the customer in their post can automatically be linked directly to the online merchant account for the merchant, so that the merchant can view the post, as shown in FIG. 10B.

If the customer selects one of the options that include their own social media page, then they can be prompted to login if they are not already logged in on the device. The post can then be published the social media page of the customer. Additionally, the post can include a link to the social media page of the merchant. This link can be automatically inserted into the post and may optionally be required depending on merchant preferences. FIG. 11 shows an example social media page 1101 associated with a customer. The page 1101 includes the published review 1102 of the merchant, as well as a link 1103 to the merchant's social media page.

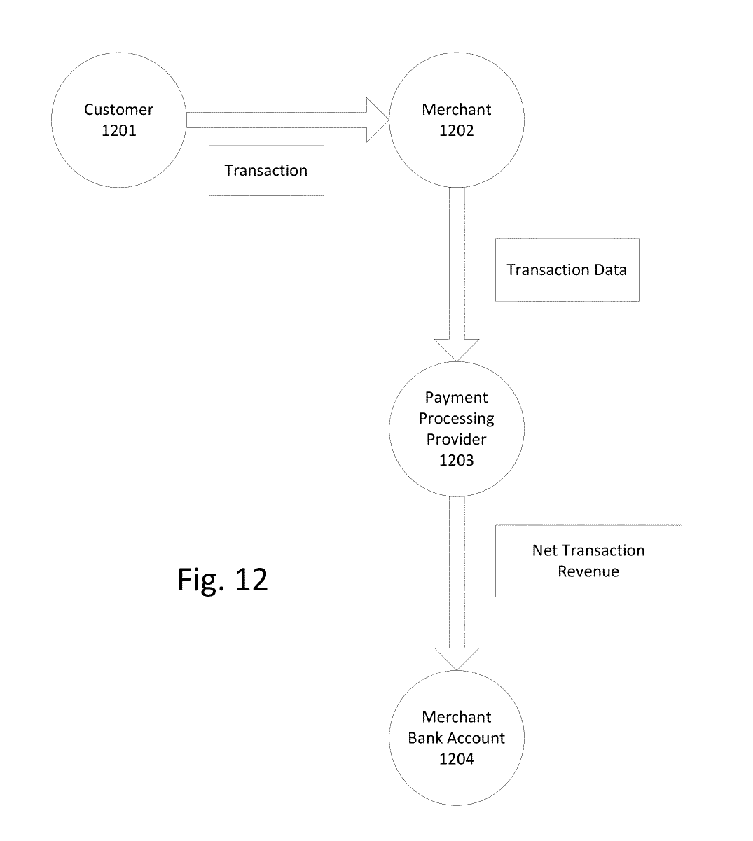

FIG. 12 illustrates a process flow for managing mobile payment transactions according to an exemplary embodiment. The customer 1201 conducts a transaction with the merchant 1202, during which the merchant captures transaction data on their mobile device. The transaction data, which includes a transaction amount, is then received by the payment processing provider 1203, which can also be the online merchant account provider. The payment processing provider 1203 calculates a net transaction revenue for the transaction. This can be the transaction amount minus processing charges and other miscellaneous charges such as sales tax. The processing charge can be a percentage of the transaction amount, a fixed amount, or a combination of both. The payment processing provider 1203 then authorizes a deposit into the bank account associated with the merchant 1203 of an amount equal to the net transaction revenue.

Merchants can optionally become premium subscribers and gain access to a variety of marketing tools through their online merchant account. These marketing tools can include custom email campaigns, loyalty programs, specialized social media tools and options, and any other premium promotional materials. As a premium subscriber, the merchant can be charged dues periodically, which can be daily, weekly, monthly, or annually. Although the merchant can pay these dues conventionally (e.g. by authorizing a payment to the online merchant account provider), the merchant can also have the option of having these dues deducted organically during the course of business.

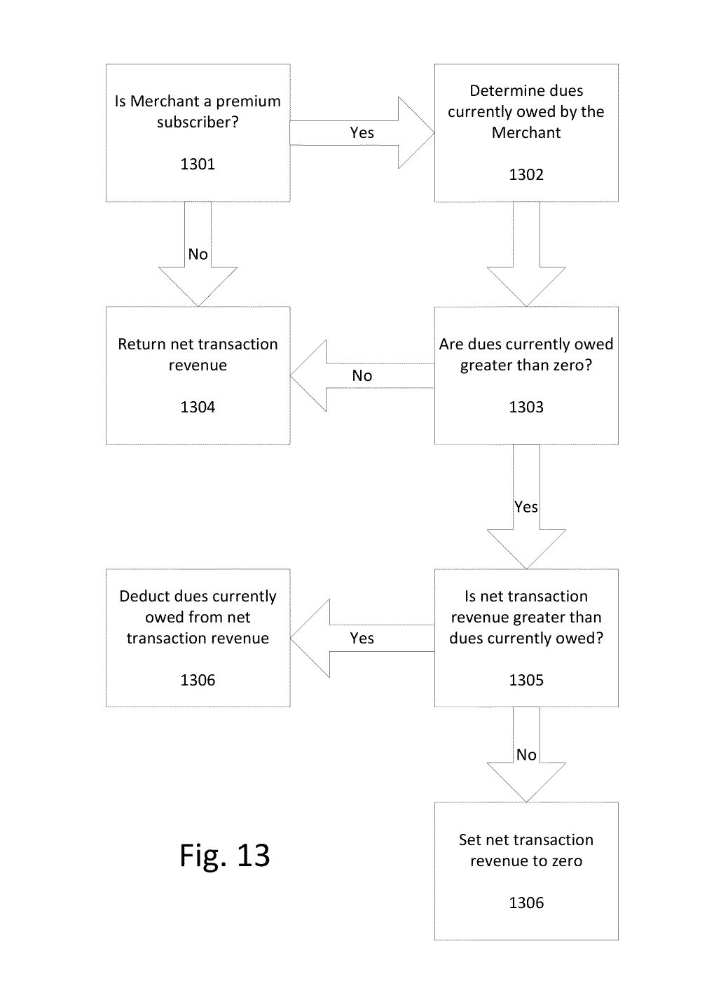

This process will now be described with reference to FIG. 13. As part of calculating the net transaction revenue, the payment processing provider can determine whether the merchant is a premium subscriber at step 1301. If the merchant is not a premium subscriber, then the net transaction revenue will be the ordinary amount as was calculated previously from the transaction amount, processing charges, and miscellaneous charges, and this amount is returned at step 1304 and eventually deposited in the bank account associated with the merchant. If the merchant is a premium subscriber, then the amount of dues currently owed can be determined at step 1302. At step 1303, a determination can be made regarding whether the amount of dues currently owed is greater than zero. If the amount of dues currently owed is not greater than zero, then the net transaction revenue is returned at step 1304. If the amount is greater than zero, then a determination made at step 1305 regarding whether the net transaction revenue is greater than the dues currently owed. If it is, then the dues currently owed are deducted from the net transaction revenue at step 1306. The merchant premium account information can be adjusted accordingly (by setting the dues currently owed to zero). If the net transaction revenue is not greater than the dues currently owed, then the net transaction revenue is set to zero at step 1306. Additionally, the merchant premium account information can be adjusted accordingly (by reducing the dues currently owed by the amount of the net transaction revenue before it was set to zero).

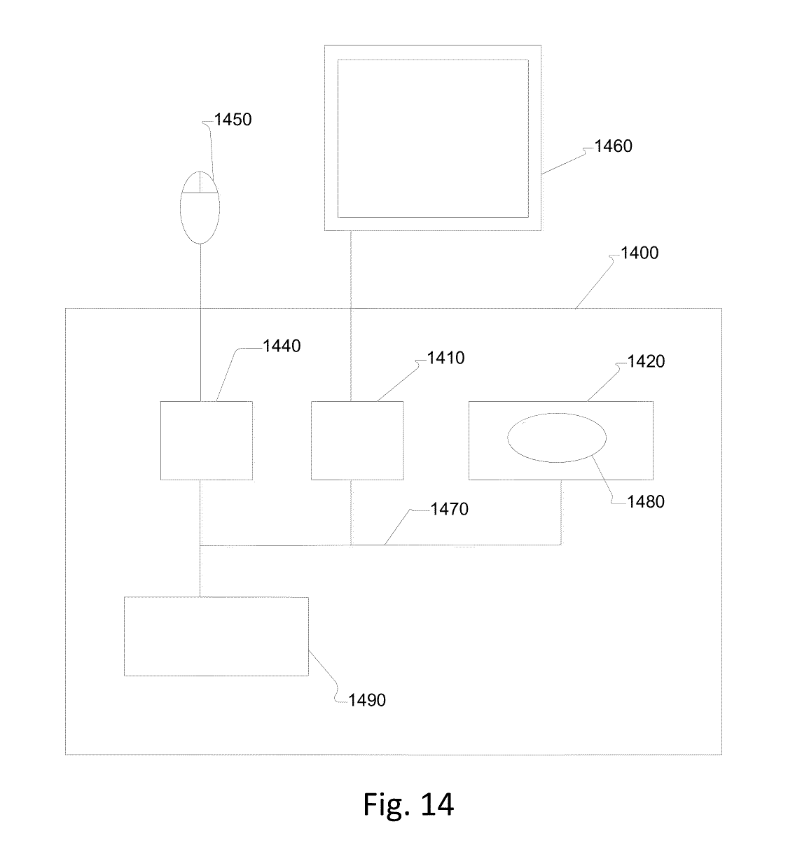

One or more of the above-described techniques can be implemented in or involve one or more computer systems. FIG. 14 illustrates a generalized example of a computing environment 1400. The computing environment 1400 is not intended to suggest any limitation as to scope of use or functionality of a described embodiment.

With reference to FIG. 14, the computing environment 1400 includes at least one processing unit 1410 and memory 1420. The processing unit 1410 executes computer-executable instructions and may be a real or a virtual processor. In a multi-processing system, multiple processing units execute computer-executable instructions to increase processing power. The memory 1420 may be volatile memory (e.g., registers, cache, RAM), non-volatile memory (e.g., ROM, EEPROM, flash memory, etc.), or some combination of the two. The memory 1420 may store software instructions 1480 for implementing the described techniques when executed by one or more processors. Memory 1420 can be one memory device or multiple memory devices.

A computing environment may have additional features. For example, the computing environment 1400 includes storage 1440, one or more input devices 1450, one or more output devices 1460, and one or more communication connections 1490. An interconnection mechanism 1470, such as a bus, controller, or network interconnects the components of the computing environment 1400. Typically, operating system software or firmware (not shown) provides an operating environment for other software executing in the computing environment 1400, and coordinates activities of the components of the computing environment 1400.

The storage 1440 may be removable or non-removable, and includes magnetic disks, magnetic tapes or cassettes, CD-ROMs, CD-RWs, DVDs, or any other medium which can be used to store information and which can be accessed within the computing environment 1400. The storage 1440 may store instructions for the software 1480.

The input device(s) 1450 may be a touch input device such as a keyboard, mouse, pen, trackball, touch screen, or game controller, a voice input device, a scanning device, a digital camera, remote control, or another device that provides input to the computing environment 1400. The output device(s) 1460 may be a display, television, monitor, printer, speaker, or another device that provides output from the computing environment 1400.

The communication connection(s) 1490 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1400, computer-readable media include memory 1420, storage 1440, communication media, and combinations of any of the above.

Of course, FIG. 14 illustrates computing environment 1400, display device 1460, and input device 1450 as separate devices for ease of identification only. Computing environment 1400, display device 1460, and input device 1450 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1400 may be a set-top box, mobile device, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method of managing mobile payment transactions by one or more computing devices, the method comprising:
receiving, by at least one of the one or more computing devices, transaction data from a mobile device of a merchant, wherein the transaction data includes payment card information associated with a customer and transaction details information relating to the transaction, and wherein the payment card information is captured with the mobile device of the merchant;
storing, by at least one of the one or more computing devices, a transaction record including the transaction details information in an online merchant account registered to the merchant, wherein the online merchant account stores a plurality of transaction records associated with the merchant; and
providing, by at least one of the one or more computing devices, access to the plurality of transaction records through the online merchant account.

2. The method of claim 1, wherein the payment card information includes a card number and the card number is captured using an image capture device on the mobile device of the merchant.

3. The method of claim 2, wherein the image capture device captures the card number without capturing an image of the entire card.

4. The method of claim 2, wherein one or more digits of the card number are obfuscated on a display of the mobile device during the capture of the card number by the image capture device.

5. The method of claim 1, wherein the payment card information is captured with at least one of voice-to-text translation of audio information input to the mobile device and text input to the mobile device.

6. The method of claim 1, wherein each transaction record in the plurality of transaction records comprises a plurality of data fields and wherein providing access to the plurality of transaction records comprises:
transmitting a table with one or more transaction records from the plurality of transaction records for display on a display device, wherein the rows of the table correspond to transaction records and the columns of the table correspond to data fields.

7. The method of claim 6, wherein providing access to the plurality of transaction records through the online merchant account further comprises:
transmitting a plurality of sort indicators, wherein each sort indicator in the plurality of sort indicators corresponds to a data field in the plurality of data fields and a sorting order;
receiving a selection of one of the plurality of sort indicators;
sorting the plurality of transaction records according to the data field and sorting order which correspond to the selected sort indicator to generate a plurality of sorted transaction records; and
updating the table with one or more sorted transaction records from the plurality of sorted transaction records.

8. The method of claim 6, wherein providing access to the plurality of transaction records through the online merchant account further comprises:
receiving a text input comprising one or more characters; and
updating the table to include only transaction records which have a data field with a data value that includes the one or more characters.

9. The method of claim 6, wherein the plurality of data fields comprise at least one of transaction date, transaction number, customer email, item purchased, status of transaction, and transaction amount.

10. The method of claim 6, wherein the plurality of data fields include transaction date, and wherein providing access to the plurality of transaction records through the online merchant account further comprises:
receiving a date range; and
updating the table to include only transaction records which have a transaction date within the date range.

11. The method of claim 1, wherein the transaction details information includes an email address of the customer, and further comprising:
transmitting, by at least one of the one or more computing devices, a receipt to the email address of the customer, wherein the receipt includes merchant information specified by the merchant through the online merchant account.

12. The method of claim 11, wherein the receipt includes a promotional offer for use with the merchant, and wherein the promotional offer is specified by the merchant through the online merchant account.

13. The method of claim 11, wherein the receipt includes a link to a social media publishing page, the social media publishing page configured to publish a post regarding the merchant on one or more social media services.

14. The method of claim 13, wherein at least one of the one or more social media services is a social network and the post is published on a social network page belonging to the merchant that is linked to the online merchant account.

15. The method of claim 13, wherein at least one of the one or more social media services is a social network and the post is published on a social network page associated with the customer, and wherein the post includes a link to a social network page belonging to the merchant that is linked to the online merchant account.

16. The method of claim 1, wherein the transaction data includes a transaction amount, and further comprising:
calculating, by at least one of the one or more computing devices, a net transaction revenue based, at least in part, on the transaction amount; and
authorizing, by at least one of the one or more computing devices, a deposit into a bank account associated with the merchant for an amount equal to the net transaction revenue.

17. The method of claim 16, wherein calculating a net transaction revenue based, at least in part, on the transaction amount comprises:
determining whether the merchant is a premium subscriber;
based on a determination that the merchant is a premium subscriber, determining an amount of dues currently owed by the merchant;
based on a determination that the merchant is a premium subscriber, the amount of dues currently owed by the merchant is greater than zero, and the net transaction revenue is greater than or equal to the amount of dues currently owed by the merchant, deducting the amount of dues currently owed by the merchant from the net transaction revenue; and
based on a determination that the merchant is a premium subscriber, the amount of dues currently owed by the merchant is greater than zero, and the net transaction revenue is less than the amount of dues currently owed by the merchant, setting the net transaction revenue to zero.

18. An apparatus for managing mobile payment transactions, the apparatus comprising:
one or more processors; and
one or more memories operatively coupled to at least one of the one or more processors and having instructions stored thereon that, when executed by at least one of the one or more processors, cause at least one of the one or more processors to:
receive transaction data from a mobile device of a merchant, wherein the transaction data includes payment card information associated with a customer and transaction details information relating to the transaction, and wherein the payment card information is captured with the mobile device of the merchant;
store a transaction record including the transaction details information in an online merchant account registered to the merchant, wherein the online merchant account stores a plurality of transaction records associated with the merchant; and
provide access to the plurality of transaction records through the online merchant account.

19. The apparatus for managing mobile payment transactions of claim 18, wherein the payment card information includes a card number and the card number is captured using an image capture device on the mobile device of the merchant.

20. The apparatus for managing mobile payment transactions of claim 19, wherein the image capture device captures the card number without capturing an image of the entire card.

21. The apparatus for managing mobile payment transactions of claim 19, wherein one or more digits of the card number are obfuscated on a display of the mobile device during the capture of the card number by the image capture device.

22. The apparatus for managing mobile payment transactions of claim 18, wherein the payment card information is captured using voice-to-text translation of audio information input to the mobile device.

23. The apparatus for managing mobile payment transactions of claim 18, wherein each transaction record in the plurality of transaction records comprises a plurality of data fields and wherein providing access to the plurality of transaction records comprises:
transmitting a table with one or more transaction records from the plurality of transaction records for display on a display device, wherein the rows of the table correspond to transaction records and the columns of the table correspond to data fields.

24. The apparatus for managing mobile payment transactions of claim 23, wherein providing access to the plurality of transaction records through the online merchant account further comprises:
transmitting a plurality of sort indicators, wherein each sort indicator in the plurality of sort indicators corresponds to a data field in the plurality of data fields and a sorting order;
receiving a selection of one of the plurality of sort indicators;
sorting the plurality of transaction records according to the data field and sorting order which correspond to the selected sort indicator to generate a plurality of sorted transaction records; and
updating the table with one or more sorted transaction records from the plurality of sorted transaction records.

25. The apparatus for managing mobile payment transactions of claim 23, wherein providing access to the plurality of transaction records through the online merchant account further comprises:
receiving a text input comprising one or more characters; and
updating the table to include only transaction records which have a data field with a data value that includes the one or more characters.

26. The apparatus for managing mobile payment transactions of claim 23, wherein the plurality of data fields comprise at least one of transaction date, transaction number, customer email, item purchased, status of transaction, and transaction amount.

27. The apparatus for managing mobile payment transactions of claim 23, wherein the plurality of data fields include transaction date, and wherein providing access to the plurality of transaction records through the online merchant account further comprises:
receiving a date range; and
updating the table to include only transaction records which have a transaction date within the date range.

28. The apparatus for managing mobile payment transactions of claim 18, wherein the transaction details information includes an email address of the customer, and wherein the one or more memories have further instructions stored thereon, that, when executed by at least one of the one or more processors, cause at least one of the one or more processors to:
transmit a receipt to the email address of the customer, wherein the receipt includes merchant information specified by the merchant through the online merchant account.

29. The apparatus for managing mobile payment transactions of claim 28, wherein the receipt includes a promotional offer for use with the merchant, and wherein the promotional offer is specified by the merchant through the online merchant account.

30. The apparatus for managing mobile payment transactions of claim 28, wherein the receipt includes a link to a social media publishing page, the social media publishing page configured to publish a post regarding the merchant on one or more social media services.

31. The apparatus for managing mobile payment transactions of claim 30, wherein at least one of the one or more social media services is a social network and the post is published on a social network page belonging to the merchant that is linked to the online merchant account.

32. The apparatus for managing mobile payment transactions of claim 30, wherein at least one of the one or more social media services is a social network and the post is published on a social network page associated with the customer, and wherein the post includes a link to a social network page belonging to the merchant that is linked to the online merchant account.

33. The apparatus for managing mobile payment transactions of claim 18, wherein the transaction data includes a transaction amount, and wherein the one or more memories have further instructions stored thereon, that, when executed by at least one of the one or more processors, cause at least one of the one or more processors to:
calculate a net transaction revenue based, at least in part, on the transaction amount; and
authorize a deposit into a bank account associated with the merchant for an amount equal to the net transaction revenue.

34. The apparatus for managing mobile payment transactions of claim 33, wherein calculating a net transaction revenue based, at least in part, on the transaction amount comprises:
determining whether the merchant is a premium subscriber;
based on a determination that the merchant is a premium subscriber, determining an amount of dues currently owed by the merchant;
based on a determination that the merchant is a premium subscriber, the amount of dues currently owed by the merchant is greater than zero, and the net transaction revenue is greater than or equal to the amount of dues currently owed by the merchant, deducting the amount of dues currently owed by the merchant from the net transaction revenue; and
based on a determination that the merchant is a premium subscriber, the amount of dues currently owed by the merchant is greater than zero, and the net transaction revenue is less than the amount of dues currently owed by the merchant, setting the net transaction revenue to zero.

35. At least one non-transitory computer-readable medium storing computer-readable instructions that, when executed by one or more computing devices, cause at least one of the one or more computing devices to:
receive transaction data from a mobile device of a merchant, wherein the transaction data includes payment card information associated with a customer and transaction details information relating to the transaction, and wherein the payment card information is captured with the mobile device of the merchant;
storing a transaction record including the transaction details information in an online merchant account registered to the merchant, wherein the online merchant account stores a plurality of transaction records associated with the merchant; and
provide access to the plurality of transaction records through the online merchant account.

36. The at least one non-transitory computer-readable medium of claim 35, wherein the payment card information includes a card number and the card number is captured using an image capture device on the mobile device of the merchant.

37. The at least one non-transitory computer-readable medium of claim 36, wherein the image capture device captures the card number without capturing an image of the entire card.

38. The at least one non-transitory computer-readable medium of claim 36, wherein one or more digits of the card number are obfuscated on a display of the mobile device during the capture of the card number by the image capture device.

39. The at least one non-transitory computer-readable medium of claim 35, wherein the payment card information is captured with at least one of voice-to-text translation of audio information input to the mobile device and text input to the mobile device.

40. The at least one non-transitory computer-readable medium of claim 35, wherein each transaction record in the plurality of transaction records comprises a plurality of data fields and wherein providing access to the plurality of transaction records comprises:
transmitting a table with one or more transaction records from the plurality of transaction records for display on a display device, wherein the rows of the table correspond to transaction records and the columns of the table correspond to data fields.

41. The at least one non-transitory computer-readable medium of claim 40, wherein providing access to the plurality of transaction records through the online merchant account further comprises:
transmitting a plurality of sort indicators, wherein each sort indicator in the plurality of sort indicators corresponds to a data field in the plurality of data fields and a sorting order;
receiving a selection of one of the plurality of sort indicators;
sorting the plurality of transaction records according to the data field and sorting order which correspond to the selected sort indicator to generate a plurality of sorted transaction records; and
updating the table with one or more sorted transaction records from the plurality of sorted transaction records.

42. The at least one non-transitory computer-readable medium of claim 40, wherein providing access to the plurality of transaction records through the online merchant account further comprises:
receiving a text input comprising one or more characters; and
updating the table to include only transaction records which have a data field with a data value that includes the one or more characters.

43. The at least one non-transitory computer-readable medium of claim 40, wherein the plurality of data fields comprise at least one of transaction date, transaction number, customer email, item purchased, status of transaction, and transaction amount.

44. The at least one non-transitory computer-readable medium of claim 40, wherein the plurality of data fields include transaction date, and wherein providing access to the plurality of transaction records through the online merchant account further comprises:
receiving a date range; and
updating the table to include only transaction records which have a transaction date within the date range.

45. The at least one non-transitory computer-readable medium of claim 35, wherein the transaction details information includes an email address of the customer, the at least one non-transitory computer-readable medium further comprising additional instructions that, when executed by one or more computing devices, cause at least one of the one or more computing devices to:
transmit a receipt to the email address of the customer, wherein the receipt includes merchant information specified by the merchant through the online merchant account.

46. The at least one non-transitory computer-readable medium of claim 45, wherein the receipt includes a promotional offer for use with the merchant, and wherein the promotional offer is specified by the merchant through the online merchant account.

47. The at least one non-transitory computer-readable medium of claim 45, wherein the receipt includes a link to a social media publishing page, the social media publishing page configured to publish a post regarding the merchant on one or more social media services.

48. The at least one non-transitory computer-readable medium of claim 47, wherein at least one of the one or more social media services is a social network and the post is published on a social network page belonging to the merchant that is linked to the online merchant account.

49. The at least one non-transitory computer-readable medium of claim 47, wherein at least one of the one or more social media services is a social network and the post is published on a social network page associated with the customer, and wherein the post includes a link to a social network page belonging to the merchant that is linked to the online merchant account.

50. The at least one non-transitory computer-readable medium of claim 35, wherein the transaction data includes a transaction amount, the at least one non-transitory computer-readable medium further comprising additional instructions that, when executed by one or more computing devices, cause at least one of the one or more computing devices to:
calculate a net transaction revenue based, at least in part, on the transaction amount; and
authorize a deposit into a bank account associated with the merchant for an amount equal to the net transaction revenue.

51. The at least one non-transitory computer-readable medium of claim 50, wherein calculating a net transaction revenue based, at least in part, on the transaction amount comprises:
determining whether the merchant is a premium subscriber;
based on a determination that the merchant is a premium subscriber, determining an amount of dues currently owed by the merchant;
based on a determination that the merchant is a premium subscriber, the amount of dues currently owed by the merchant is greater than zero, and the net transaction revenue is greater than or equal to the amount of dues currently owed by the merchant, deducting the amount of dues currently owed by the merchant from the net transaction revenue; and
based on a determination that the merchant is a premium subscriber, the amount of dues currently owed by the merchant is greater than zero, and the net transaction revenue is less than the amount of dues currently owed by the merchant, setting the net transaction revenue to zero.
